(19) United States
(12) Patent Application Publication
(10) Pub. No.: US 2011/0220389 A1
(43) Pub. Date: Sep. 15, 2011

(54) ULTRAFINE SHIELDED CABLE AND HARNESS USING THE SAME

(75) Inventors: Detian HUANG, Hitachi (JP); Takanobu Watanabe, Hitachi (JP); Noriyuki Imai, Hitachi (JP)

(73) Assignee: HITACHI CABLE FINE-TECH, LTD.

(21) Appl. No.: 13/037,652

(22) Filed: Mar. 1, 2011

(30) Foreign Application Priority Data
Mar. 9, 2010 (JP) 2010-051804

(51) Int. Cl. H01B 11/02

(52) U.S. Cl. 174/113 R

(57) ABSTRACT

An ultrafine shielded cable includes a twisted wire formed by twisting a coated wire and an external conductor together, the external conductor composed of metal wires being placed side by side vertically along a longitudinal direction of the coated wire having an insulation layer therein formed on a periphery of an inner conductor, a shield layer provided on a periphery of the twisted wire for collectively covering the coated wire and the external conductor, and a jacket provided on a periphery of the shield layer to cover thereof. The shield layer is helically wound so that a conductive wire strip formed by a rolling process is in contact with the external conductor.

The present application is based on Japanese Patent Application No. 2010-051804 filed on Mar. 9, 2010, the entire contents of which are incorporated herein by reference.

### BACKGROUND OF THE INVENTION

1. Field of the Invention

The invention relates to an ultrafine shielded cable used frequently for medical use and a harness using the same, and, in particular, to an ultrafine shielded cable with an improved terminal connectivity (or a simplified terminal workability during the connection) of a shield portion and a harness using the same.

2. Description of the Related Art

As a cable used for transmitting signals in a mobile phone or medical equipments such as gastroscope or ultrasonic endoscope, a shielded cable provided with, e.g., an inner conductor, an insulation layer provided on a periphery of the inner conductor, a shield layer provided on a periphery of the insulation layer and a jacket provided on a periphery of the shield layer is widely used. Especially in recent years, an ultrafine shielded cable with an outer diameter of 0.3 mm or less in which a served shield is employed for a shield layer as a shield portion is used due to demands of electric properties such as EMI (Electro Magnetic Interference) characteristics or SKEW characteristics, thinning associated with space saving at a terminal connection portion in a mobile phone and diameter reduction to relieve suffering of patients at the time of swallowing an endoscope.

In detail, as shown in FIGS. 9 and 10, ultrafine shielded cables 90 and 100 have one or plural coated wires 93 formed by coating inner conductors 91 with an insulation layer 92, a shield layer 95 provided on an outer periphery of the coated wire 93 and composed of a served shield formed of multiple spiral strands 94, and a jacket 96 covering an outer periphery of the shield layer 95.

The related art may include, e.g., JP-A 2001-28209 and JP-A 10-247425.

### SUMMARY OF THE INVENTION

A conventional ultrafine shielded cable using a served shield as a shield layer is used to connect at its end to, e.g., a CCD camera provided at an end of a gastroscope or an endoscope, a head of the endoscope, or an end portion of a catheter inserted into a blood vessel, etc. Here, since a space at a connecting portion of on a device side is small (or narrow), there is a problem that it is difficult to conduct the terminal processing (i.e., connecting the terminal to a ground electrode of the device) of a shield layer which is composed of plural (about 20-30) spiral strands with a small outer diameter (an outer diameter of about 25-30 μm). For example, the connection of an ultrafine shielded cable to a device is often carried out by stripping a jacket and a shield layer at a different level of an end portion of the cable to make a coated wire protrude and bending the coated wire at a pitch interval of electrodes which are connected to an inner conductor of the device.

Then, the shield layer protruding from the jacket is connected to a ground electrode of the device. When the shield layer in the spiral shape is placed on and connected to the ground electrode, a problem may occur in that spiral strands at the end portion of the shield layer get stuck in the coated wire, penetrate through the insulation layer and contact the inner conductor, resulting in a short circuit.

Furthermore, in bundling multiple spiral strands composing the protruding shield layer and then placing them on the ground electrode for connection, it is necessary to separate the multiple spiral strands once and then bundle the spiral strands which have been separated in multiple directions due to winding are required in order to bundle the spiral strands. Thus, there is a problem that time-consuming works are required.

Furthermore, since a large space is required for the terminal processing of the multiple spiral strands, it is not suitable for reducing a diameter of the whole device.

Therefore, it is an object of the invention to provide an ultrafine shielded cable that can facilitate the terminal processing (for the connection to the ground electrode of a device) of a shield layer even in a narrow space, and to provide a harness using the same.

(1) According to one embodiment of the invention, an ultrafine shielded cable comprises:

a twisted wire formed by twisting a coated wire and an external conductor together, the external conductor composed of metal wires being placed side by side vertically along a longitudinal direction of the coated wire having an insulation layer therein formed on a periphery of an inner conductor;

a shield layer provided on a periphery of the twisted wire for collectively covering the coated wire and the external conductor; and

a jacket provided on a periphery of the shield layer to cover thereof,

wherein the shield layer is helically wound so that a conductive wire strip formed by a rolling process is in contact with the external conductor.

In the above embodiment (1) of the invention, the following modifications and changes can be made.

(i) In the twisted wire, a plurality of the coated wires arranged in parallel are twisted together with a plurality of the external conductors arranged so as to be symmetrical to the coated wire in a direction perpendicular to an array direction of the coated wires.

(ii) An outer diameter of the external conductor is 0.7 times that of the coated wire, and a thickness of the conductive wire strip is not less than 1/10 and not more than ⅓ the outer diameter of the external conductor.

(iii) The insulation layer comprises a fluorine resin, and the jacket comprises a plastic tape with an adhesive layer or a fluorine resin.

(2) According to another embodiment of the invention, a harness comprises:

the ultrafine shielded cable according to the above embodiment (1),

wherein the inner conductor and the shield layer each protrude from the jacket at both ends the cable,

the protruding inner conductor is connected to an electrode used for connection to the inner conductor of a connector, and

the conductive wire strip of the protruding shield layer is connected to a ground electrode of the connector, or, the external conductor is connected to a ground electrode of the connector.

(3) According to another embodiment of the invention, a harness comprises:

a tape-shaped cable with a plurality of the ultrafine shielded cables according to the above embodiment (1) arranged in parallel,

wherein the inner conductor and the shield layer each protrude from the jacket at both ends the cable,

the protruding inner conductor is connected to an electrode used for connection to the inner conductor of a connector, and

the conductive wire strip of the protruding shield layer is connected to a ground electrode of the connector, or, the external conductor is connected to a ground electrode of the connector.

In the above embodiment (2) or (3) of the invention, the following modifications and changes can be made.

(iv) The conductive wire strip is deformed and is held an inner space of the connector.

Points of the Invention

According to one embodiment of the invention, an ultrafine shielded cable is constructed such that a shield layer (composed of a single conductive wire strip) is in contact with an external conductor, where one of the single conductive wire strip (composing the shield layer) and the external conductor may be connected to a ground electrode of a device for completing the connection between the shield layer and the ground electrode, unlike the conventional shield layer. Therefore, it is possible to facilitate the terminal processing of the shield layer during the cable connection even in a narrow space, thereby significantly reducing the connection work time.

### BRIEF DESCRIPTION OF THE DRAWINGS

Next, the present invention will be explained in more detail in conjunction with appended drawings, wherein:

FIG. 1 is a cross sectional view showing an ultrafine shielded cable in an embodiment of the present invention;

FIG. 2 is a perspective view showing a terminal portion of the ultrafine shielded cable of FIG. 1;

FIG. 3 is a view for explaining connection between the ultrafine shielded cable of FIG. 1 and a device;

FIG. 4 is a cross sectional view showing an ultrafine shielded cable in another embodiment of the invention;

FIG. 5 is a perspective view showing a terminal portion of the ultrafine shielded cable of FIG. 4;

FIG. 6 is a cross sectional view showing a tape-shaped cable using the ultrafine shielded cable of FIG. 1;

FIG. 7 is a cross sectional view showing a tape-shaped cable using the ultrafine shielded cable of FIG. 4;

FIG. 8 is a top view showing a harness using an ultrafine shielded cable of the invention;

FIG. 9 is a cross sectional view showing a conventional ultrafine twin core shielded cable; and

FIG. 10 is a cross sectional view showing a conventional ultrafine single core shielded cable.

### DETAILED DESCRIPTION OF THE PREFERRED EMBODIMENTS

A preferred embodiment of the invention will be described below in conjunction with the appended drawings.

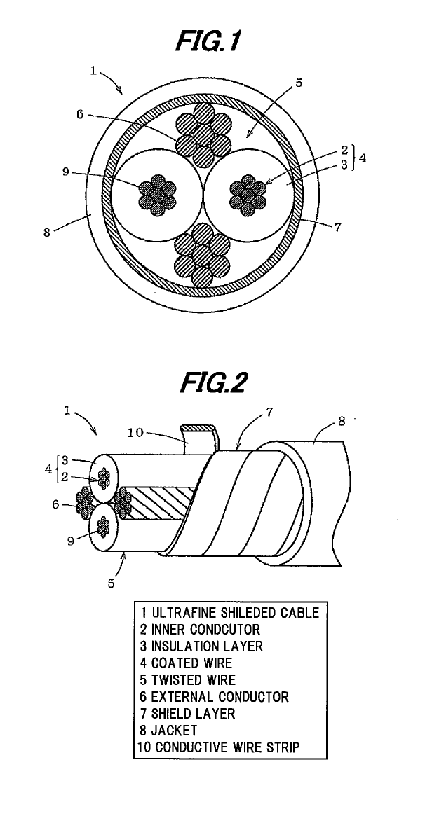

FIG. 1 is a cross sectional view showing an ultrafine shielded cable in an embodiment of the invention. FIG. 2 is a perspective view showing a terminal portion of the ultrafine shielded cable of FIG. 1.

As shown in FIGS. 1 and 2, an ultrafine shielded cable 1 in the present embodiment is provided with a twisted wire 5 in which external conductors 6 composed of metal wires are arranged side by side vertically along a longitudinal direction of a coated wire 4 having an insulation layer 3 therein formed on a periphery of an inner conductor 2 and the coated wires 4 are twisted together with the external conductors 6, a shield layer 7 provided on a periphery of the twisted wire 5 for collectively covering the coated wire 4 and external conductor 6, and a jacket 8 provided on a periphery of the shield layer 7 to cover thereof. The ultrafine shielded cable 1 is formed having an outer diameter of 0.3 mm or less because it is wired in a narrow space in a device such as mobile phone, gastroscope or catheter and is repeatedly twisted.

The inner conductor 2 is formed by twisting plural copper wires 9 (e.g., silver-plated copper alloy wires) together. It is desirable that the copper wire 9 is 40 AWG (7/0.028-0.032) to 48 AWG (7/0.011-0.015) in size given that it is passed through a hinge portion of a mobile phone, or inside of gastroscope or catheter. The insulation layer 3 is formed of a fluorine resin such as tetrafluoroethylene-perfluoroalkyl vinyl ether copolymer (PFA) resin, tetrafluoroethylene-hexafluoropropylene copolymer (FEP) resin or ethylene-tetrafluoroethylene copolymer (ETFE) resin.

The external conductor 6 is formed of, e.g., a single or plural twisted metal wires such as annealed copper wire. The external conductors 6 are symmetrically arranged so as to sandwich the coated wires 4 because noise generated when using a device with two ground wires is cancelled out each other by arranging the ground wires composed of the external conductors 6 to be symmetrical, and a decrease in electric properties due to noise is thereby suppressed. As the external conductor 6, it is desirable to use a single or twisted tin- or silver-plated copper or copper alloy wire.

In addition, size of outer diameter of the external conductor 6 is preferably 0.7 times that of the coated wire 4. Thus, the cable can have a round shape by arranging the external conductors 6 without gap in a portion where there is a space in the conventional ultrafine shielded cable 90 shown in FIG. 9, and further, it is possible to prevent the outer diameter from being larger than that of the conventional ultrafine shielded cable 90. In light of diameter reduction and flex resistance of the ultrafine shielded cable 1, the outer diameter of the coated wire 4 is preferably not less than 0.07 mm and not more than 0.21 mm.

In the twisted wire 5, plural coated wires 4 (two wires in FIGS. 1 and 2) are arranged in parallel and plural external conductors 6 (two conductors in FIGS. 1 and 2) are arranged in a direction perpendicular to an array direction of the coated wire 4 so as to be symmetrical to the coated wires 4 and are twisted together with the coated wires 4. In other words, a pair of external conductors 6 is twisted together after being arranged to face each other in a direction perpendicular to the array direction of the coated wire 4 at a position where the adjacent coated wires 4 are in contact with each other.

A plastic tape (polyester tape) with an adhesive layer made of a material which is thin and resistant to bending is lap-wound so that the adhesive layer is located on an inner side (on the twisted wire 5 side), thereby forming the jacket 8. Alternatively, the jacket 8 is formed by extruding a fluorine resin (e.g., PFA, FEP or ETFE) so as to cover the shield layer 7.

In the ultrafine shielded cable 1 of the present embodiment, a conductive wire strip 10 formed by a rolling process is helically wound so as to be in contact with the external conductor 6 to provide the shield layer 7. In detail, the conductive wire strip 10 formed by a rolling process so as to have a cross section with a width of 0.1-0.4 mm and a thickness of 0.006-0.026 mm is used for the shield layer 7, and the conductive wire strip 10 is helically wound around the outer peripheries of the coated wire 4 and the external conductor 6 so that the side surfaces of the conductive wire strip 10 (a pair of surfaces of the conductive wire strip 10 located in a width direction (a horizontal direction in FIG. 2) and facing each other) are butted up against one another, thereby forming the shield layer 7.

It is preferred that the conductive wire strip 10 obtained by performing a rolling process has a tensile strength (σ₁) after the rolling process of the copper or copper alloy wire higher than a tensile strength (σ₀) before the rolling process thereof. Especially, it is preferred that a ratio of a difference between the tensile strength (σ₁) after the rolling process of the copper or copper alloy wire and the tensile strength (σ₀) before the rolling process thereof to the tensile strength (σ₀) before the rolling process thereof (an increasing rate of tensile strength due to the process=100×(σ₁−σ₀)/σ₀) is more than 0% and not more than 50% or less (0%<100×(σ₁−σ₀)/σ₀<50%). It is preferred that the tensile strength (σ₀) before the rolling process of the copper or copper alloy wire is not less than 300 MPa. It is preferred that the conductive wire strip obtained by performing a rolling process has a breaking elongation (δ₁) after the rolling process of the copper or copper alloy wire is higher than breaking elongation (δ₀) before the rolling process thereof. Especially, a ratio of a difference between the breaking elongation (δ₁) after the rolling process or the copper or copper alloy wire and the breaking elongation (δ₀) before the rolling process thereof to the breaking elongation (δ₀) before the rolling process thereof (an increasing rate of breaking elongation due to the process=100×(δ₁−δ₀)/δ₀) is preferably not less than 10% and not more than 60% (10%<100×(δ₁−δ₀)/δ₀<60%), more preferably, not less than 20% and not more than 50%. The above-mentioned tensile strength (σ) and the breaking elongation (δ) of the copper or copper alloy wire are obtained by a test method conforming to JIS standard (JIS Z 2241, “Method of tensile test for metallic materials”).

At this time, the shield layer 7 is wound so as to be in contact with two external conductors 6. In other words, it is a state in which the external conductors 6 are in contact with the inner surface of the shield layer 7 in a longitudinal direction, a shield is integrally formed by the shield layer 7 and the external conductors 6 and electric properties equivalent to or more excellent than the prior art are obtained. In addition, the flex resistance is improved since the conductive wire strip 10 is thinner than a spiral strand which forms a conventional served shield.

Here, the conductive wire strip 10 is wound without overlapping in light of diameter reduction of the ultrafine shielded cable 1. When the conductive wire strip 10 is wound without overlapping as just described, the conductive wire strip 10 may be coiled without contact between the side surfaces thereof. If the conductive wire strip 10 is coiled as just described, noise may be superimposed on a signal which is normally transmitted in the inner conductor 2 by the coil. However, in the ultrafine shielded cable 1 of the present embodiment, since the conductive wire strip 10 contacts with itself along a longitudinal direction of the external conductor 6, noise generation level can be suppressed to the level equivalent to the conventional served shield even if the conductive wire strip 10 is coiled.

The thickness of the conductive wire strip 10 is not less than 1/10 and not more than ⅓ the outer diameter of the external conductor 6 in light of hardness of the entire cable and solder joint reliability of the shield layer 7. Then, for example, a round copper or copper alloy wire with an outer diameter of 30 μm is rolled and drawn into a thickness of 6 μm and a width of 110 μm, thereby forming the conductive wire strip 10.

Since the conductive wire strip 10 composing the shield layer 7 is formed by a rolling process as described above, in case of changing (deforming) the shape of the conductive wire strip 10 by bending, etc., a function (property) which allows to maintain a shape after the deformation and a function (property) which allows to change the maintained shape after the deformation into a new shape and to maintain the new shape can be provided.

Therefore, the winding, etc., can be easily straightened at the time of connecting the shield layer 7 to the ground electrode even if the conductive wire strip 10 has the winding caused by being helically wound, and the ground electrode can be connected to the conductive wire strip 10 (the shield layer 7) by appropriately changing and maintaining the shape taking into account a space, etc., at a connecting portion when connecting to the ground electrode.

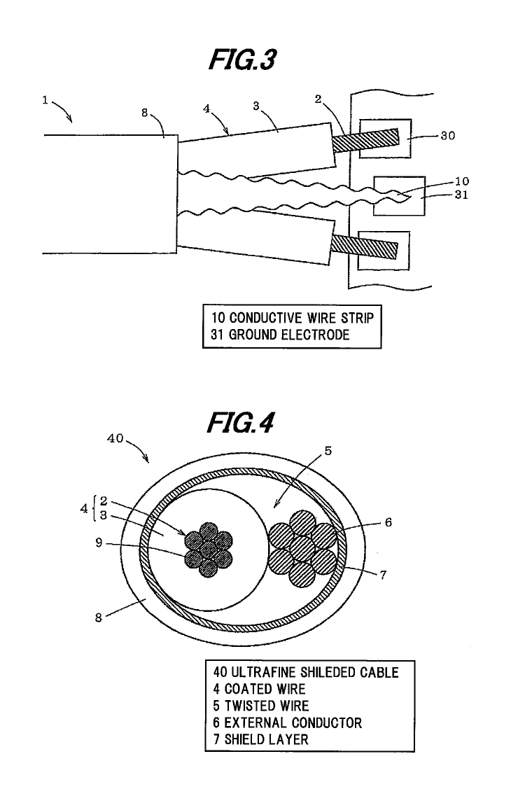

As a result, it is possible to facilitate the terminal processing of the shield layer 7 without necessity of cumbersome work and time. An example thereof will be described using FIG. 3.

As shown in FIG. 3, for connecting the ultrafine shielded cable 1 to a device, the shield layer 7, the coated wire 4 and the inner conductor 2 are made to sequentially protrude from the jacket 8 at an end portion of the ultrafine shielded cable 1, and the inner conductor 2 is then connected to an inner conductor electrode 30 provided on the device while the conductive wire strip 10 of the shield layer 7 is pulled out while uncoiling and is then connected to a ground electrode 31 provide on the device. At this time, the conductive wire strip 10 in a twisted state may be connected to the ground electrode 31 without change, or, the conductive wire strip 10 may be wound around the external conductor 6 and then connected to the ground electrode 31.

At this time, in the ultrafine shielded cable 1, the shield layer 7 is formed of a single conductive wire strip 10 and thus is not separated when the jacket 8 is removed unlike the conventional served shield, and the shape is thereby maintained.

Meanwhile, since the shield layer 7 is in contact with the external conductor 6, the problem such as the conductive wire strip 10 getting stuck in the coated wire 4 can be suppressed only by connecting the external conductor 6 to the ground electrode 31 without connecting the shield layer 7 to the ground electrode 31 by holding the shield layer 7 in a space not affecting the device or the coated wire 4 (e.g., a space inside a connector which is connected to a terminal of the ultrafine shielded cable) by changing the shape such as by rolling up the conductive wire strip 10 composing the shield layer 7.

In sum, in the ultrafine shielded cable 1 of the present embodiment, since a conductor to be connected to the ground electrode 31 of the device may be only a single conductive wire strip 10 or only the external conductor 6, it is possible to facilitate the terminal processing of the shield layer 7 even in a narrow space, thereby significantly reducing connecting work time.

In addition, the shield layer 7 composed of the conductive wire strip 10 is thinner (size in a thickness direction can be reduced) than a shield layer using a conventional round spiral strand, which results in contributing to the diameter reduction of the ultrafine shielded cable 1. Furthermore, since the shield layer 7 is thinner than the conventional shield layer, damage on the shield layer 7 when being bent is less than the prior art and it is thereby possible to improve the flex resistance.

The above-described ultrafine shielded cable 1 shown in FIG. 1 can be used as an interconnection in which, e.g., a Low Voltage Differential Signaling (LVDS) method is employed. In this case, a current of, e.g., about 0.5-5V and several tens to 250 Am is transmitted in the ultrafine shielded cable.

An ultrafine shielded cable in another embodiment of the invention will be described below.

As shown in FIGS. 4 and 5, in an ultrafine shielded cable 40 in the other embodiment, a single coated wire 4 and an external conductor 6 are placed vertically side by side and are twisted together to form the twisted wire 5, and then, an outer periphery of the twisted wire 5 is coated with the shield layer 7 and the jacket 8 sequentially.

In the ultrafine shielded cable 40, since the conductive wire strip 10 similar to that of the ultrafine shielded cable 1 shown in FIG. 1 is also used for forming the shield layer 7, it is possible to facilitate the terminal processing of the shield layer 7 even in a narrow space in the same manner as the ultrafine shielded cable 1, thereby significantly reducing connecting work time.

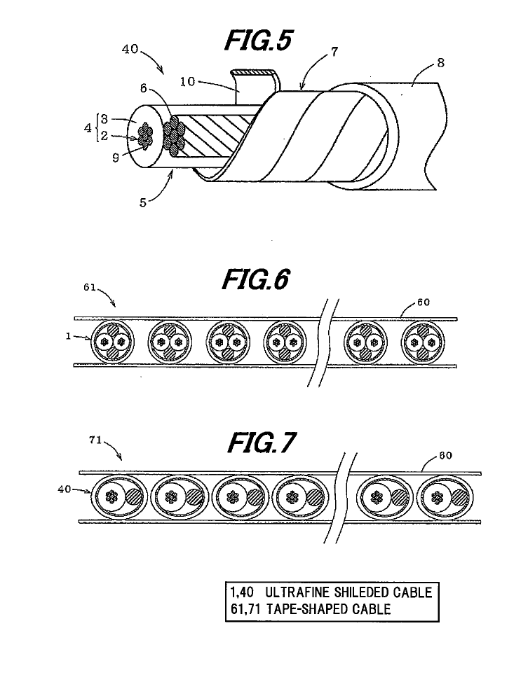

In addition, as shown in FIGS. 6 and 7, an assembly of plural ultrafine shielded cables 1 or 40 mentioned above (e.g., about 200 cables) can be used as a probe cable of an ultrasonograph. For multichannel transmission, plural ultrafine shielded cables 1 or 40 which are arranged in parallel and sandwiched by laminate films 60, etc., may be used as a tape-shaped cable 61 or 71 as shown in FIGS. 6 and 7.

Lastly, a harness using the ultrafine shielded cable 1 or 40 will be described.

The inner conductor 2 and the shield layer 7 are made to protrude from the jacket 8 at both ends of the ultrafine shielded cable 1 or 40, the protruding inner conductor 2 is connected to an electrode used for connection to an inner conductor of a connector, the conductive wire strip 10 composing the protruding shield layer 7 is pulled out while uncoiling and is then connected to a ground electrode of the connector, and the harness using the ultrafine shielded cable 1 or 40 is thereby formed. Alternatively, only the external conductor 6 may be connected to the ground electrode of the connector without connecting the shield layer 7 thereto. At this time, the problem such as the conductive wire strip 10 getting stuck in the coated wire 4 can be suppressed by holding the shield layer 7 in a space not affecting the connector, the device or the coated wire 4 by changing the shape such as by rolling up the conductive wire strip 10 composing the shield layer 7.

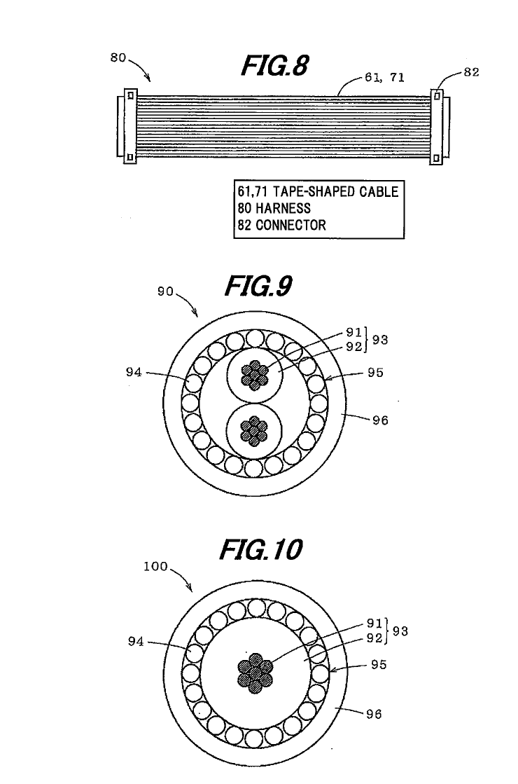

In addition, as shown in FIG. 8, a connector 82 is each connected to both ends of the tape-shaped cable 61 or 71 which is formed by arranging plural ultrafine shielded cables 1 or 40 in parallel, thereby forming a harness 80 compatible with multichannel transmission.

As described above, in the present invention, the ultrafine shielded cable is provided with a twisted wire in which a coated wire having an insulation layer therein formed on a periphery of an inner conductor is twisted together with an external conductor composed of metal wires placed side by side vertically along a longitudinal direction of the coated wire, a shield layer provided on a periphery of the twisted wire for collectively covering the coated wire and the external conductor and a jacket provided on a periphery of the shield layer to cover thereof, and the shield layer is helically wound so that a conductive wire strip formed by a rolling process is in contact with the external conductor, therefore, it is possible to facilitate the terminal processing of the shield layer 7 even in a narrow space in a device.

Although the invention has been described with respect to the specific embodiment for complete and clear disclosure, the appended claims are not to be therefore limited but are to be construed as embodying all modifications and alternative constructions that may occur to one skilled in the art which fairly fall within the basic teaching herein set forth.

What is claimed is:

1. An ultrafine shielded cable, comprising:
a twisted wire formed by twisting a coated wire and an external conductor together, the external conductor composed of metal wires being placed side by side vertically along a longitudinal direction of the coated wire having an insulation layer therein formed on a periphery of an inner conductor;
a shield layer provided on a periphery of the twisted wire for collectively covering the coated wire and the external conductor; and
a jacket provided on a periphery of the shield layer to cover thereof,
wherein the shield layer is helically wound so that a conductive wire strip formed by a rolling process is in contact with the external conductor.

2. The ultrafine shielded cable according to claim 1, wherein, in the twisted wire, a plurality of the coated wires arranged in parallel are twisted together with a plurality of the external conductors arranged so as to be symmetrical to the coated wire in a direction perpendicular to an array direction of the coated wires.

3. The ultrafine shielded cable according to claim 1, wherein an outer diameter of the external conductor is 0.7 times that of the coated wire, and
a thickness of the conductive wire strip is not less than 1/10 and not more than ⅓ the outer diameter of the external conductor.

4. The ultrafine shielded cable according to claim 1, wherein the insulation layer comprises a fluorine resin, and
the jacket comprises a plastic tape with an adhesive layer or a fluorine resin.

5. A harness, comprising:
the ultrafine shielded cable according to claim 1,
wherein the inner conductor and the shield layer each protrude from the jacket at both ends the cable,
the protruding inner conductor is connected to an electrode used for connection to the inner conductor of a connector, and
the conductive wire strip of the protruding shield layer is connected to a ground electrode of the connector, or, the external conductor is connected to a ground electrode of the connector.

6. A harness, comprising:
a tape-shaped cable with a plurality of the ultrafine shielded cables according to claim 1 arranged in parallel,
wherein the inner conductor and the shield layer each protrude from the jacket at both ends the cable,
the protruding inner conductor is connected to an electrode used for connection to the inner conductor of a connector, and
the conductive wire strip of the protruding shield layer is connected to a ground electrode of the connector, or, the external conductor is connected to a ground electrode of the connector.

7. The harness according to claim 5, wherein the conductive wire strip is deformed and is held an inner space of the connector.

8. The harness according to claim 6, wherein the conductive wire strip is deformed and is held an inner space of the connector.
